(19) United States
(12) Patent Application Publication
(10) Pub. No.: US 2026/0125251 A1
(43) Pub. Date: May 7, 2026

(54) VEHICLE FRAME RACK

(71) Applicants: TOYOTA JIDOSHA KABUSHIKI KAISHA, Toyota-shi (JP); ALTIA CO., LTD., Tokyo (JP)

(72) Inventors: Mamoru SETOGUCHI, Toyota-shi (JP); Jun Sato, Kawaguchi-shi (JP)

(73) Assignees: TOYOTA JIDOSHA KABUSHIKI KAISHA, Toyota-shi (JP); ALTIA CO., LTD., Tokyo (JP)

(21) Appl. No.: 19/334,266

(22) Filed: Sep. 19, 2025

(30) Foreign Application Priority Data
Nov. 1, 2024 (JP) 2024-193018

(51) Int. Cl. B66F 7/28

(52) U.S. Cl. CPC B66F 7/28

(57) ABSTRACT

A vehicle frame rack includes first to fourth support portions, movable in a vehicle width or a vehicle length direction with respect to each other and supporting first to fourth wheels, respectively of the vehicle. Further, the support portions include respective height display portions and lifting adjustment portions.

### CROSS-REFERENCE TO RELATED APPLICATION(S)

The present application claims priority to and incorporates by reference the entire contents of Japanese Patent Application No. 2024-193018 filed in Japan on Nov. 1, 2024.

### BACKGROUND

The present disclosure relates to a vehicle frame rack.

Japanese Laid-open Patent Publication No. H8-245191 discloses, as a frame rack for automobile maintenance which can be easily adjusted to an appropriate height, can be easily used, and has improved usability, a frame rack in which a hydraulic jack the supporting head of which is lifted/lowered is fixed to a top base of a three-legged base. A configuration in which it is possible to support vehicles having different dimensions of a wheelbase or a tread by using four bases and adjusting positions of the bases according to the dimensions of the vehicles is described.

### SUMMARY

There is a need for providing a vehicle frame rack that can facilitate leveling of a vehicle and achieve high safety in work of removing a heavy object that is a battery.

According to an embodiment, a vehicle frame rack includes: a first support portion that supports a first wheel of a vehicle; a second support portion that supports a second wheel of the vehicle which wheel is separated from the first wheel in a width direction of the vehicle; a third support portion that supports a third wheel of the vehicle which wheel is separated from the first wheel in a length direction of the vehicle; a fourth support portion that supports a fourth wheel of the vehicle which wheel is separated from the third wheel in the width direction of the vehicle; a first frame rack having the first support portion and the second support portion at a predetermined height; and a second frame rack separated from the first frame rack and having the third support portion and the fourth support portion at a predetermined height. Further, in the first frame rack, the first support portion or the second support portion moves in the width direction of the vehicle, in the second frame rack, the third support portion and the fourth support portion move in a length direction of the vehicle, the third support portion or the fourth support portion also moves in the width direction, the first support portion includes, between itself and the first frame rack, a first height display portion and a first lifting adjustment portion, the second support portion includes, between itself and the first frame rack, a second height display portion and a second lifting adjustment portion, the third support portion includes, between itself and the second frame rack, a third height display portion and a third lifting adjustment portion, and the fourth support portion includes, between itself and the second frame rack, a fourth height display portion and a fourth lifting adjustment portion.

According to an embodiment, a vehicle frame rack includes: a first support portion that supports a first wheel of a vehicle; a second support portion that supports a second wheel of the vehicle which wheel is separated from the first wheel in a width direction of the vehicle; a third support portion that supports a third wheel of the vehicle which wheel is separated from the first wheel in a length direction of the vehicle; a fourth support portion that supports a fourth wheel of the vehicle which wheel is separated from the third wheel in the width direction of the vehicle; a first frame rack having the first support portion and the second support portion at a predetermined height; and a second frame rack separated from the first frame rack and having the third support portion and the fourth support portion at a predetermined height. Further, in the first frame rack, the first support portion or the second support portion moves in the width direction of the vehicle, in the second frame rack, the third support portion and the fourth support portion move in the length direction of the vehicle, the third support portion or the fourth support portion also moves in the width direction, the first frame rack includes a first beam laid in the width direction, the first beam includes a first beam bottom portion, and first beam side wall portions at both ends in the width direction above the first beam bottom portion, the first support portion or the second support portion includes, on a bottom surface thereof, a first spring, which is deformed by weight of the vehicle, and a first wheel or a second spring and a second wheel, and the first wheel or the second wheel moves inside in the width direction the first beam side wall portions while rolling on the first beam bottom portion, the second frame rack includes a second beam laid in the length direction, and a first movable portion that moves along the second beam, the first movable portion includes the third support portion, the second beam includes a second beam bottom portion, and second beam side wall portions at both ends in the width direction above the second beam bottom portion, the first movable portion includes, on a bottom surface thereof, a third spring, which is deformed by the weight of the vehicle, and a third wheel, and the third wheel moves inside the second beam side wall portions in the width direction while rolling on the second beam bottom portion, the first movable portion further includes a third beam laid in the width direction and a second movable portion that moves along the third beam, the second movable portion includes the fourth support portion, the third beam includes a third beam bottom portion, and third beam side wall portions at both ends in the width direction above the third beam bottom portion, the second movable portion includes, on a bottom surface thereof, a fourth spring, which is deformed by the weight of the vehicle, and a fourth wheel, and the fourth wheel moves inside the third beam side wall portions in the width direction while rolling on the third beam bottom portion, a dimension in the height direction of the first spring and the first wheel or a dimension in the height direction of the second spring and the second wheel in a state in which the vehicle is not mounted on the vehicle frame rack is larger than a dimension in the height direction of the first beam side wall portions, and the dimension in the height direction of the first spring and the first wheel or the dimension in the height direction of the second spring and the second wheel in a state in which the vehicle is mounted on the vehicle frame rack is equal to or smaller than the dimension in the height direction of the first beam side wall portions, a dimension in the height direction of the third spring and the third wheel in a state in which the vehicle is not mounted on the vehicle frame rack is larger than a dimension in the height direction of the second beam side wall portions, and the dimension in the height direction of the third spring and the third wheel in a state in which the vehicle is mounted on the vehicle frame rack is equal to or smaller than the dimension in the height direction of the second beam side wall portions, and a dimension in the height direction of the fourth spring and the fourth wheel in a state in which the vehicle is not mounted on the vehicle frame rack is larger than a dimension in the height direction of the third beam side wall portions, and the dimension in the height direction of the fourth spring and the fourth wheel in a state in which the vehicle is mounted on the vehicle frame rack is equal to or smaller than the dimension in the height direction of the third beam side wall portions.

### BRIEF DESCRIPTION OF THE DRAWINGS

FIG. 1A is a plan view of a vehicle frame rack according to an embodiment;

FIG. 1B is a front view of the vehicle frame rack according to the embodiment;

FIG. 1C is a view taken along a line A-A in FIG. 1A;

FIG. 1D is a view taken along a line B-B in FIG. 1A;

FIG. 2 is a side view of a battery electric vehicle;

FIG. 3 is a front view of the vehicle frame rack before the battery electric vehicle is placed;

FIG. 4A is a view for describing work of placing the battery electric vehicle on the vehicle frame rack;

FIG. 4B is a view for describing the work of placing the battery electric vehicle on the vehicle frame rack;

FIG. 5A is a view illustrating a state in which the battery electric vehicle is placed on the vehicle frame rack;

FIG. 5B is a view illustrating a state before the battery electric vehicle is placed on the vehicle frame rack;

FIG. 5C is a view illustrating a state before and after the battery electric vehicle is placed on a height adjustment frame rack of the vehicle frame rack;

FIG. 5D is a view illustrating a state before and after the battery electric vehicle is placed on a wheel holding frame rack of the vehicle frame rack;

FIG. 6 is a view for describing work of taking out a driving battery from the battery electric vehicle;

FIG. 7 is a front view of a vehicle frame rack according to a modification example;

FIG. 8A is a schematic diagram of a movable portion according to the modification example; and

FIG. 8B is a schematic diagram of the movable portion according to the modification example.

### DETAILED DESCRIPTION

In the technology described in Japanese Laid-open Patent Publication No. H8-245191, first, it is difficult to perform adjustment for horizontally supporting a vehicle in a case where a vehicle such as a battery electric vehicle or a wrecked car in a state a part of wheels is missing, is to be supported at portions of the wheels. In a case where a battery as a heavy object is removed from a vehicle on which the battery is mounted, and is transferred to a mounting table or the like, when the vehicle is inclined, there are problems such as the battery falling and the risk of an operator's hand being caught between the battery and the mounting table. Second, there is a problem that it takes time and effort to set a fixing metal fitting or the like for preventing movement after moving a movable support portion according to the dimensions of the wheelbase or the tread of the vehicle.

Hereinafter, an embodiment of the present disclosure will be described in detail with reference to the accompanying drawings. Note that the present disclosure is not limited by the embodiment described in the following. In addition, in the description of the drawings, the same or corresponding elements are appropriately denoted by the same reference signs. Furthermore, it should be noted that the drawings are schematic, and a dimensional relationship and the like of the elements may be different from actual ones. Portions having different dimensional relationships and ratios may be included between the drawings. An orthogonal coordinate system of an X axis, a Y axis, and a Z axis is appropriately illustrated in the drawings, and directions will be described according thereto. A direction in which an X component increases in a space indicated by the orthogonal coordinate system is referred to as a +X direction, and a direction in which the X component decreases is referred to as a −X direction. Similarly, Y and Z components are also defined as a +Y direction, a −Y direction, a +Z direction, and a −Z direction.

### Embodiment

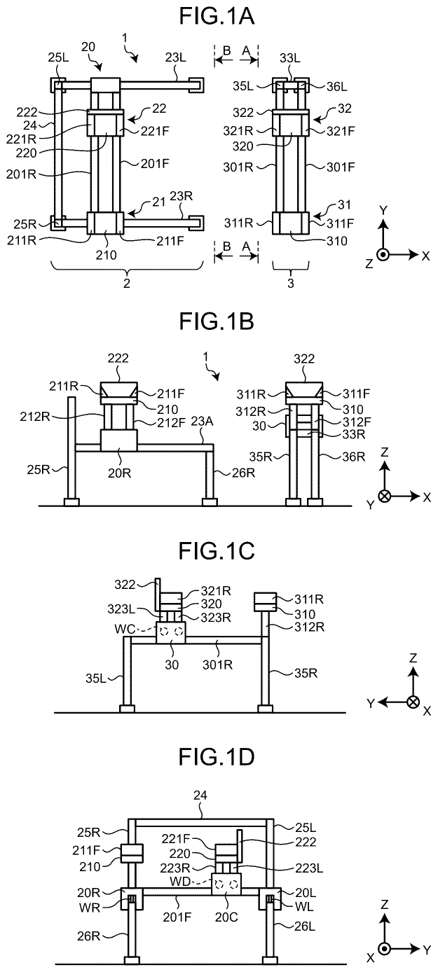

FIG. 1A is a plan view of a vehicle frame rack 1 according to an embodiment of the present disclosure, and FIG. 1B is a front view of the vehicle frame rack 1. In addition, FIG. 1C is a view taken along a line A-A in FIG. 1A, and FIG. 1D is a view taken along a line B-B in FIG. 1A. The vehicle frame rack 1 is a frame rack on which a battery electric vehicle is placed. The metal vehicle frame rack 1 includes a second frame rack 2, and a first frame rack 3 separated from the second frame rack 2. The vehicle frame rack 1 is used for work of taking out a driving battery for driving a battery electric vehicle (BEV) from under a floor of the battery electric vehicle. Note that the application of the vehicle frame rack 1 is not limited to the work of taking out the driving battery from the battery electric vehicle. For example, the vehicle frame rack 1 may be used for work of placing an electric vehicle such as a hybrid electric vehicle (HEV) or a plug-in hybrid electric vehicle (PHEV) and taking out a secondary battery from under a floor of the electric vehicle. In addition, the vehicle frame rack 1 may be used for work of placing a fuel cell electric vehicle (FCEV) and taking out a fuel cell mounted under a floor of the fuel cell electric vehicle from under the floor. In addition, the vehicle frame rack 1 may be used to place a vehicle driven by an engine and for work under a floor.

The second frame rack 2 includes a support column 25L, a support column 25R, a support column 26L, and a support column 26R. The support column 25L, the support column 25R, the support column 26L, and the support column 26R are prismatic columns, but may be H-beam steel. The support column 25L is in the +Y direction of the support column 25R, and the support column 26R is in the +X direction of the support column 25R. Furthermore, the support column 26L is in the +Y direction of the support column 26R. The support column 25R and the support column 25L have the same length, and the support column 26R and the support column 26L have the same length. The length of the support column 25R and the support column 25L is longer than the length of the support column 26R and the support column 26L.

In addition, the second frame rack 2 includes a beam 23R, a beam 23L, and a beam 24. The beam 23R is a member laid from the support column 25R to the support column 26R in an X-axis direction, and the beam 23L is a member laid from the support column 25L to the support column 26L in the X-axis direction. The beam 23R and the beam 23L are examples of a second beam according to the present disclosure.

In addition, between the beam 23L and the beam 23R, the second frame rack 2 has a rear wheel support portion 20 movable in the +X direction and the −X direction. The rear wheel support portion 20 includes a movable portion 20L, a movable portion 20R, a beam 201F, a beam 201R, a third support portion 21, and a fourth support portion 22. In order to prevent falling off from the beam 23L, the movable portion 20L has a recessed shape that sandwiches the beam 23L in a Y-axis direction, and includes a wheel WL in contact with an upper surface of the beam 23L. In order to prevent falling off from the beam 23R, the movable portion 20R has a recessed shape that sandwiches the beam 23R in the Y-axis direction and includes a wheel WR in contact with an upper surface of the beam 23R. The movable portion 20R and the movable portion 20L are an example of a first movable portion according to the present disclosure. The beam 201F and the beam 201R are members laid from the movable portion 20L to the movable portion 20R in the Y-axis direction. The beam 201F and the beam 201R are examples of a third beam according to the present disclosure.

The third support portion 21 that supports a right rear wheel that is an example of a third wheel of the battery electric vehicle placed on the vehicle frame rack 1 is provided on the movable portion 20R. The third support portion 21 includes a support leg 212F, a support leg 212R, a bottom plate 210, a wheel stopper 211F, and a wheel stopper 211R. The support leg 212F is provided at an end portion in the +X direction on an upper surface of the movable portion 20R, and the support leg 212R is provided at an end portion in the −X direction on the upper surface of the movable portion 20R. The support leg 212F and the support leg 212R support the rectangular plate-shaped bottom plate 210. On an upper surface of the bottom plate 210, the wheel stopper 211F having a triangular prism shape is provided at an end portion in the +X direction, and the wheel stopper 211R having a triangular prism shape is provided at an end portion in the −X direction. Note that although not illustrated, the third support portion 21 may be provided on the movable portion 20L.

The fourth support portion 22 that supports a left rear wheel that is an example of a fourth wheel of the battery electric vehicle placed on the vehicle frame rack 1 is provided on the beam 201F and the beam 201R. The fourth support portion 22 includes a movable portion 20C, a support leg 223R, a support leg 223L, a bottom plate 220, a wheel stopper 221F, a wheel stopper 221R, and a side plate 222. In order to prevent falling off from the beam 201F and the beam 201R, the movable portion 20C has a recessed shape that sandwiches the beam 201F and the beam 201R in the X-axis direction, and includes a wheel WD in contact with an upper surface of the beam 201F and a wheel WD in contact with an upper surface of the beam 201R. The movable portion 20C is an example of a second movable portion according to the present disclosure. The support leg 223L is provided at an end portion in the +Y direction on an upper surface of the movable portion 20C, and the support leg 223R is provided at an end portion in the −Y direction on the upper surface of the movable portion 20C. The support leg 223L and the support leg 223R support the rectangular plate-shaped bottom plate 220. On the upper surface of the bottom plate 210, the wheel stopper 221F having a triangular prism shape is provided at an end portion in the +X direction, and the wheel stopper 221R having a triangular prism shape is provided at an end portion in the −X direction. The side plate 222 has a rectangular plate shape, and is fixed to end surfaces on the +Y direction side of the bottom plate 220, the wheel stopper 221F, and the wheel stopper 221R. A height of the side plate 222 in the +Z direction is higher than the height of the wheel stopper 221F and the wheel stopper 221R.

The first frame rack 3 includes a support column 35L, a support column 35R, a support column 36L, and a support column 36R. The support column 35L, the support column 35R, the support column 36L, and the support column 36R are prismatic columns, but may be H-beam steel. The support column 35L is in the +Y direction of the support column 35R, and the support column 36R is in the +X direction of the support column 35R. Furthermore, the support column 36L is in the +Y direction of the support column 36R.

In addition, the first frame rack 3 includes a beam 33R, a beam 33L, a beam 301F, and a beam 301R. The beam 33R is a member laid from the support column 35R to the support column 36R in the X-axis direction, and the beam 33L is a member laid from the support column 35L to the support column 36L in the X-axis direction. The beam 301F is a member laid from the support column 36R to the support column 36L in the Y-axis direction, and the beam 301R is a member laid from the support column 35R to the support column 35L in the Y-axis direction. The beam 301F and the beam 301R are an example of a first beam according to the present disclosure.

In addition, the first frame rack 3 includes a first support portion 31 that supports a right front wheel that is an example of a first wheel of the battery electric vehicle placed on the vehicle frame rack 1. The first support portion 31 includes a support leg 312F, a support leg 312R, a bottom plate 310, a wheel stopper 311F, and a wheel stopper 311R. The support leg 312F is provided on the support column 36R, and the support leg 312R is provided on the support column 35R. The support leg 312F and the support leg 312R support the rectangular plate-shaped bottom plate 310. On an upper surface of the bottom plate 310, the wheel stopper 311F having a triangular prism shape is provided at an end portion in the +X direction, and the wheel stopper 311R having a triangular prism shape is provided at an end portion in the −X direction.

In addition, the first frame rack 3 includes a second support portion 32 that supports a left front wheel that is an example of a second wheel of the battery electric vehicle placed on the vehicle frame rack 1. The second support portion 32 includes a movable portion 30, a support leg 323R, a support leg 323L, a bottom plate 320, a wheel stopper 321F, a wheel stopper 321R, and a side plate 322. In order to prevent falling off from the beam 301F and the beam 301R, the movable portion 30 has a recessed shape that sandwiches the beam 301F and the beam 301R in the X-axis direction, and includes a wheel WC in contact with an upper surface of the beam 301F and a wheel WC in contact with an upper surface of the beam 301R. The support leg 323L is provided at an end portion in the +Y direction on an upper surface of the movable portion 30, and the support leg 323R is provided at an end portion in the −Y direction on the upper surface of the movable portion 30. The support leg 323L and the support leg 323R support the rectangular plate-shaped bottom plate 320. On an upper surface of the bottom plate 320, the wheel stopper 321F having a triangular prism shape is provided at an end portion in the +X direction, and the wheel stopper 321R having a triangular prism shape is provided at an end portion in the −X direction. The side plate 322 has a rectangular plate shape, and is fixed to end surfaces on the side of the +Y direction of the bottom plate 320, the wheel stopper 321F, and the wheel stopper 321R. A height of the side plate 322 in the +Z direction is higher than the height of the wheel stopper 321F and the wheel stopper 321R.

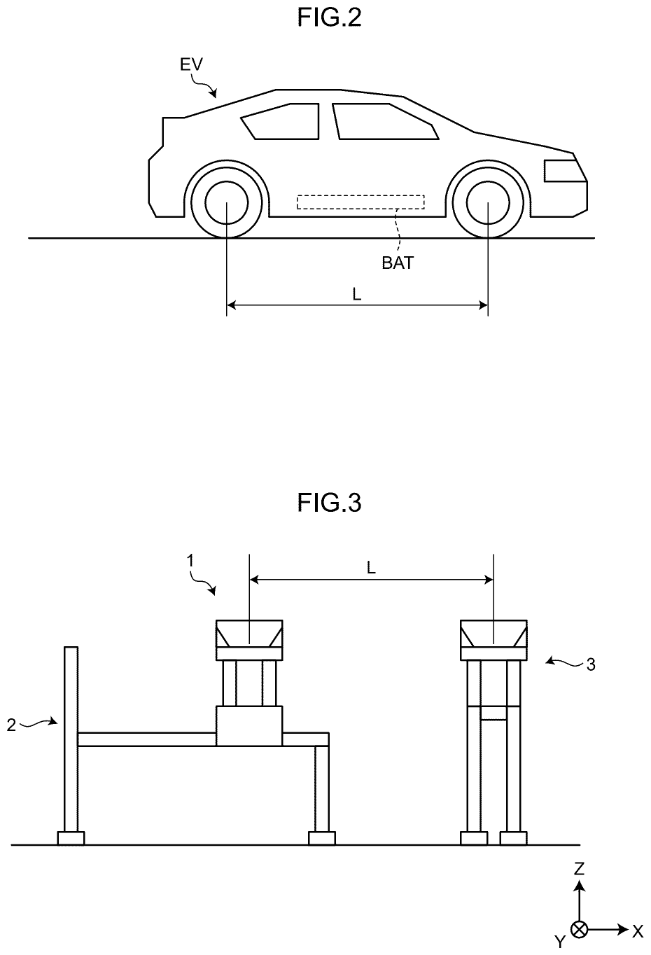

FIG. 2 is a side view of the battery electric vehicle EV. The battery electric vehicle EV has a driving battery BAT serving as a power source of a motor that drives wheels under a floor. A wheelbase of the battery electric vehicle EV is L, and a tread width is W in the following description.

FIG. 3 is a front view of the vehicle frame rack 1 before the battery electric vehicle EV is placed. An operator who removes the driving battery BAT from the battery electric vehicle EV first moves the rear wheel support portion 20 in the X-axis direction in such a manner that an interval between the first support portion 31 and the third support portion 21 and an interval between the second support portion 32 and the fourth support portion 22 become L that is the wheelbase of the battery electric vehicle EV. Here, since the rear wheel support portion 20 is movable in the X-axis direction by the wheel WR of the movable portion 20R and the wheel WL of the movable portion 20L, the operator can easily adjust the interval between the first support portion 31 and the third support portion 21 and the interval between the second support portion 32 and the fourth support portion 22.

In addition, the operator sets an interval between the first support portion 31 and the second support portion 32 to be shorter than W of the tread width, and sets an interval between the third support portion 21 and the fourth support portion 22 to an interval shorter than W of the tread width. Here, since the second support portion 32 is movable in the Y-axis direction by the wheels WC of the movable portion 30 and the fourth support portion 22 is movable in the Y-axis direction by the wheel WD of the movable portion 20C, the operator can easily adjust the interval between the first support portion 31 and the second support portion 32 and the interval between the third support portion 21 and the fourth support portion 22.

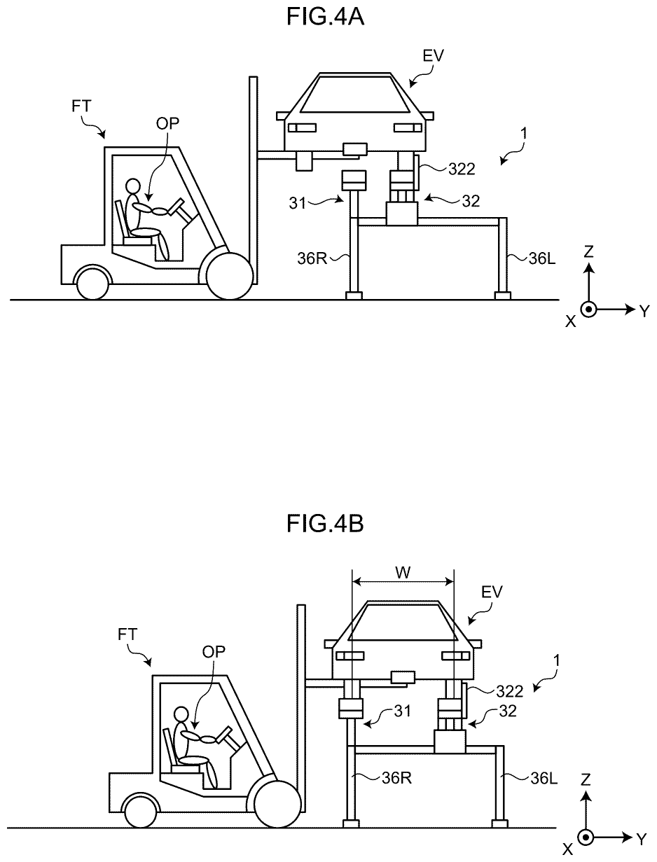

FIG. 4A and FIG. 4B are views for describing work of placing the battery electric vehicle EV on the vehicle frame rack 1. As illustrated in FIG. 4A, the operator OP places the battery electric vehicle EV on a fork of a forklift FT, presses a left side surface of the left front wheel against the side plate 322, presses a left side surface of the left rear wheel against the side plate 222, and moves the battery electric vehicle EV in the +Y direction. Since the left side surface of the left front wheel is pressed against the side plate 322 and the left side surface of the left rear wheel is pressed against the side plate 222, as illustrated in FIG. 4B, the second support portion 32 is moved in the +Y direction by the movable portion 30, and the fourth support portion 22 is moved in the +Y direction by the movable portion 20C.

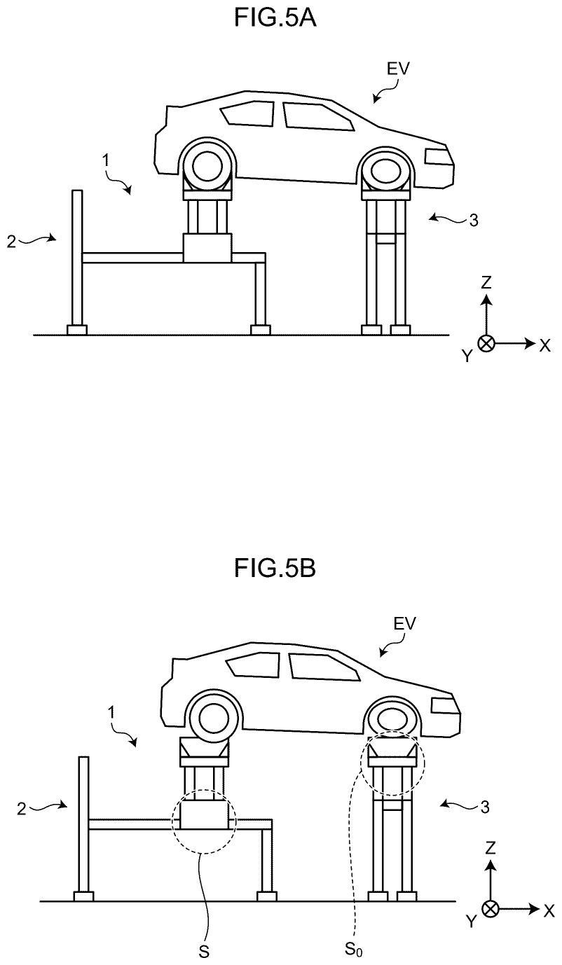

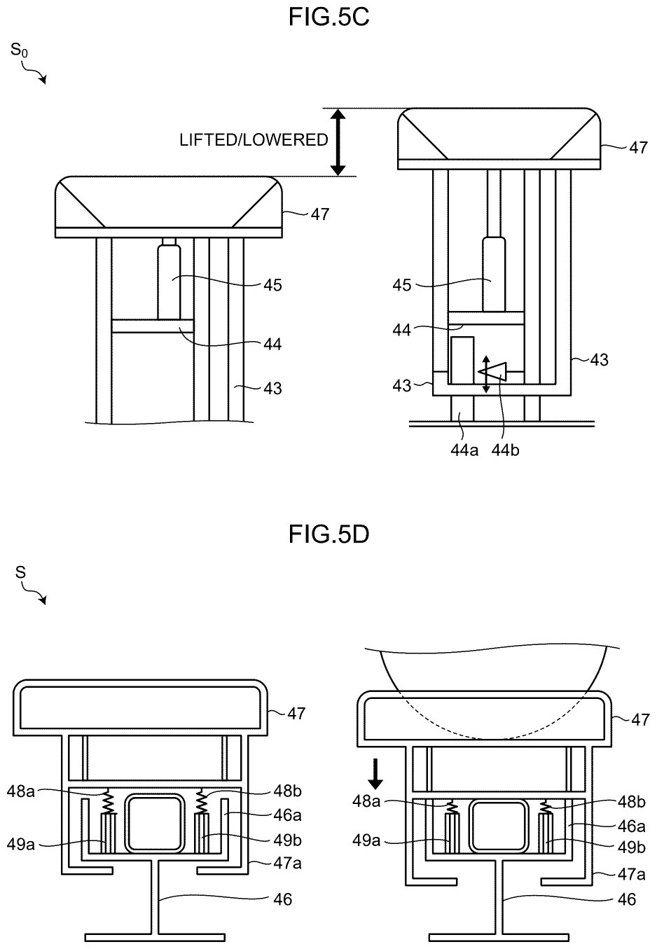

FIG. 5A is a view illustrating a state in which the battery electric vehicle EV is placed on the vehicle frame rack 1. When the right front wheel is located on the first support portion 31 and the right rear wheel is located on the third support portion 21 as illustrated in FIG. 4B, the operator OP lowers the fork of the forklift FT, places the right front wheel on the first support portion 31, places the left front wheel on the second support portion 32, places the right rear wheel on the third support portion 21, and places the left rear wheel on the fourth support portion 22. Since each wheel of the battery electric vehicle EV placed on the vehicle frame rack 1 is located between the wheel stoppers of each of the support portions, movement in a front-rear direction is controlled.

FIG. 5B is a view illustrating a state immediately before the battery electric vehicle EV is placed on the vehicle frame rack 1. As illustrated in FIG. 5B, even when the interval between the first support portion 31 and the third support portion 21 and the interval between the second support portion 32 and the fourth support portion 22 are longer than the wheelbase L, the right rear wheel of the battery electric vehicle EV comes into contact with the wheel stopper 211F and the left rear wheel comes into contact with the wheel stopper 221F when the fork of the forklift FT is lowered, whereby the movable portion 20L and the movable portion 20R move in the +X direction. Thus, the interval between the first support portion 31 and the third support portion 21 and the interval between the second support portion 32 and the fourth support portion 22 can be adjusted to L that is the wheelbase of the battery electric vehicle EV.

FIG. 5C is a view illustrating a state before and after the battery electric vehicle is placed on a height adjustment frame rack of the vehicle frame rack according to an embodiment. FIG. 5C also illustrates each tire support portion lifting mechanism according to the present embodiment as illustrated in FIG. 5B. An example illustrated in FIG. 5C is an enlarged view illustrating a region S₀ that is a part of the support portion.

That is, as illustrated in FIG. 5C, the first support portion 31 includes, between itself and the first frame rack 3, a scale 44a and a lifting amount display portion 44b that are first height display portions, and a hydraulic jack 45 that is a first lifting adjustment portion. Similarly, the second support portion 32 includes, between itself and the first frame rack 3, a scale 44a and a lifting amount display portion 44b that are second height display portions, and a hydraulic jack 45 that is a second lifting adjustment portion. Furthermore, the third support portion 21 includes, between itself and the second frame rack 2, a scale 44a and a lifting amount display portion 44b that are third height display portions, and a hydraulic jack 45 that is a third lifting adjustment portion. Similarly, the fourth support portion 22 includes, between itself and the second frame rack 2, a scale 44a and a lifting amount display portion 44b that are fourth height display portions, and a hydraulic jack 45 that is a fourth lifting adjustment portion.

As illustrated in FIG. 5C, a hollow quadrangular prism tire support guide 43 is arranged around a tire support base 44. Furthermore, a hydraulic jack 45 fixed to the tire support base 44 is included. The tire support guide 43 can be raised and lowered along the tire support base 44 by lifting/lowering operation of the hydraulic jack 45. That is, the tire support guide 43, the tire support base 44, and the hydraulic jack 45 are included in a lifting mechanism. By utilization of the scales 44a and the lifting amount display portions 44b respectively attached to four places of the tire support bases 44, a lifting amount of each of the tire support guides 43 is adjusted by utilization of a trigonometric ratio or a trigonometric function with respect to an inclination angle of the vehicle mounted on the first to fourth frame racks. This makes it possible to accurately adjust horizontal state of the vehicle.

As described above, even in a case where a part of tires is missing in a wrecked car or the like, the vehicle can be lifted and lowered by the hydraulic jacks 45 built in the support portions of the tires, and a horizontal state of the vehicle can be clarified and held accurately by the attached scales 44a and the lifting amount display portions 44b. That is, even in a case where a part of the tires is missing, such as a case of the wrecked car, by jacking up or jacking down the hydraulic jack 45 in the tire support base 44 at the portion where the tire is missing, and combining a height displacement amount for a height, with which the inclination angle is about 0 degrees, by calculating an inclination from the scale 44a and the lifting amount display portion 44b attached to each of the tire support bases 44 or by using an inclinometer (not illustrated), it is possible to secure the horizontal state of the vehicle with high accuracy and accurately perform adjustment to a receiving surface (horizontal surface) of a table lifter or the forklift, whereby the battery can be lowered horizontally.

FIG. 5D is a view illustrating a state before and after the battery electric vehicle is placed on a wheel holding frame rack of the vehicle frame rack. FIG. 5D is a view illustrating an example of each of the support portions. The example illustrated in FIG. 5D is an enlarged view illustrating the region S that is a part of the support portion illustrated in FIG. 5B.

That is, as illustrated in FIG. 5D, the first frame rack 3 has the beams 301F and 301R as the first beam laid in a width direction. Each of the beams 301F and 301R has a first beam bottom portion, and first beam side wall portions at both ends in the width direction above the first beam bottom portion. The first support portion 31 or the second support portion 32 includes, on a bottom surface thereof, a spring 48a, which is a first spring deformed by weight of the vehicle, and a wheel 49a that is a first wheel, or a spring 48b that is a second spring and a wheel 49b that is a second wheel. The wheel 49a or the wheel 49b moves inside in the width direction of traveling rail side walls 46a, which are the first beam side wall portions, while rolling on a traveling rail 46 that is the first beam bottom portion. The second frame rack 2 includes the beams 23R and 23L as the second beam laid in a length direction, and the movable portions 20R and 20L as the first movable portion that moves along the beams 23R and 23L. The movable portions 20R and 20L as the first movable portion have the third support portion 21, and each of the beams 23R and 23L as the second beam has a second beam bottom portion and traveling rail side walls 46a as the second beam side wall portions at both ends in the width direction above the second beam bottom portion. The movable portions 20R and 20L as the first movable portion include, on the bottom surfaces thereof, a spring 48a as a third spring, which is deformed by the weight of the vehicle, and a wheel 49a as the third wheel. The wheel 49a that is the third wheel moves inside in the width direction of the traveling rail side walls 46a, which are the second beam side wall portions, while rolling on the traveling rail 46 that is the second beam bottom portion. The movable portions 20R and 20L that are the first movable portion further include the beams 201F and 201R as the third beam laid in the width direction, and the movable portion 20C as the second movable portion that moves along the beams 201F and 201R. The movable portion 20C has the fourth support portion 22, and each of the beams 201F and 201R that are the third beam has a traveling rail that is a third beam bottom portion, and traveling rail side walls 46a that are third beam side wall portions at both ends in the width direction above the third beam bottom portion. The movable portion 20C that is the second movable portion includes, on a bottom surface thereof, a spring 48b, which is a fourth spring deformed by the weight of the vehicle, and a wheel 49b that is a fourth wheel, and the wheel 49b moves inside in the width direction of the traveling rail side walls 46a, which are the third beam side wall portions while rolling on the traveling rail 46 that is the third beam bottom portion. A dimension in the height direction of the spring 48a that is the first spring and the wheel 49a that is the first wheel or a dimension in the height direction of the spring 48b that is the second spring and the wheel 49b that is the second wheel in a state in which the vehicle is not mounted on the vehicle frame rack is larger than a dimension in the height direction of the traveling rail side walls 46a that are the first beam side wall portions, and the dimension in the height direction of the spring 48a that is the first spring and the wheel 49a that is the first wheel or the dimension in the height direction of the spring 48b that is the second spring and the wheel 49b that is the second wheel in a state in which the vehicle is mounted on the vehicle frame rack is equal to or smaller than the dimension in the height direction of the traveling rail side walls 46a that are the first beam side wall portions. A dimension in the height direction of the spring 48a that is the third spring and the wheel 49a that is the third wheel in a state in which the vehicle is not mounted on the vehicle frame rack is larger than a dimension in the height direction of the traveling rail side walls 46a that are the second beam side walls, and the dimension in the height direction of the spring 48a that is the third spring and the wheel 49a that is the third wheel in a state in which the vehicle is mounted on the vehicle frame rack is equal to or smaller than the dimension in the height direction of the traveling rail side walls 46a that are the second beam side wall portions. A dimension in the height direction of the spring 48b that is the fourth spring and the wheel 49b that is the fourth wheel in a state in which the vehicle is not mounted on the vehicle frame rack is larger than the dimension in the height direction of the traveling rail side walls 46a that are the third beam side wall portions, and a dimension in the height direction of the spring 48b that is the fourth spring and the wheel 49b that is the fourth wheel in a state in which the vehicle is mounted on the vehicle frame rack is equal to or smaller than the dimension in the height direction of the traveling rail side walls 46a that are the third beam side wall portions.

As a result, a tire support portion 47 that can be arbitrarily adjusted in the front-rear direction and the right-left direction according to a size of the vehicle has a traveling function, and the springs 48a and 48b in a lower portion of the tire support portion 47 sink due to the weight of the vehicle after the vehicle is set. As a result, since the lower portion of the tire support portion 47 and the upper portion of the traveling rail 46 strongly interfere with each other, frictional resistance between the lower portion of the tire support portion 47 and the upper portion of the traveling rail 46 controls forward and backward movement and rightward and leftward movement, and the position can be maintained.

Specifically, as illustrated in FIG. 5D, the tire support portion 47, the springs 48a and 48b, and the wheels 49a and 49b are integrally configured. Before the vehicle is set and mounted (left view in FIG. 5D), the lower portion of the tire support portion 47 and the upper portion of the traveling rail 46 are in a non-contact state by an action of the springs 48a and 48b. In this state, since the tire support portion 47 is freely movable in the front-rear direction and the right-left direction, adjustment to the size of the vehicle becomes possible.

Subsequently, when the vehicle is mounted, the tire support portion 47 raised by the springs 48a and 48b sinks, strongly interferes with the upper portion of the traveling rail side walls 46a of the traveling rail 46, and is fixed by friction, whereby the position of the tire support portion 47 is maintained. At the same time, since it is possible to prevent a load of the entire weight of the vehicle to the wheels 49a and 49b from being applied, a part of the weight of the vehicle is dispersed and applied to the traveling rail 46, the traveling rail side walls 46a, and the tire support portion 47, whereby durability of the wheels 49a and 49b can be improved.

With such a configuration, by the springs 48a and 48b provided in the wheels 49a and 49b of each traveling truck, in movement in the front-rear direction and the right-left direction, the traveling truck can smoothly move in the front-rear direction and the right-left direction without contact of the front-rear beams or the right-left beams. In addition, after the vehicle is mounted, each of the tire support portions having the traveling function and each truck sink via the springs 48a and 48b in each of the traveling rails 46 due to the weight of the vehicle, strong interference with each of the traveling trucks and the front and rear beams and the right and left beams is caused to disperse the weight of the vehicle, and the load on traveling wheels of the traveling truck can be further reduced, whereby the durability can be improved. In addition, since it is possible to save trouble of setting the fixing metal fittings for preventing the movement of the truck at the four locations, the work efficiency can be improved.

In the related art, when a vehicle is set on a frame rack in a state in which a part of wheels of a wrecked car or the like is missing, it is difficult to maintain the vehicle horizontally. Thus, when an in-vehicle battery is removed by a table lifter or a forklift, an inclination of the vehicle does not become horizontal, and the in-vehicle battery is unloaded in an unstable state. As a result, there is a possibility that a hand of an operator is caught by a fall of the in-vehicle battery, and that the in-vehicle battery falls to the ground due to force of the fall and the operator is caught or the battery is damaged. In addition, the entire weight of the vehicle is applied to one portion of a fixed tire support portion and traveling wheels of three portions of receiving portions of tires, and durability of the three portions of the tire support portions having a traveling function is lowered, whereby it becomes difficult to smoothly perform front-rear and right-left movement. Furthermore, even when four fixing tools for preventing the movement are set in the tire support portions having the traveling function, there is a problem that efficiency of fixing every time is low due to a difference in size of vehicles.

On the other hand, in the present embodiment, by attaching the up-down lifting mechanisms to the tire support portions, it is possible to horizontally hold a vehicle even when at least one wheel, two wheels, or three wheels of the four wheels of a suspension are missing, for example, in a case of a wrecked car. When a part such as a large driving battery mounted under a floor is removed, the removal can be performed with a horizontal state being stably maintained in accordance with a table lifter, a flat pallet, or the like of a clamping jig. In addition, it becomes possible to automatically fix the tire support portions, which are capable of arbitrarily moving in the wheelbase and the tread direction, at arbitrary positions by the weight of the vehicle from a mechanism that manually fixes the tire support portions in accordance with a size of the vehicle.

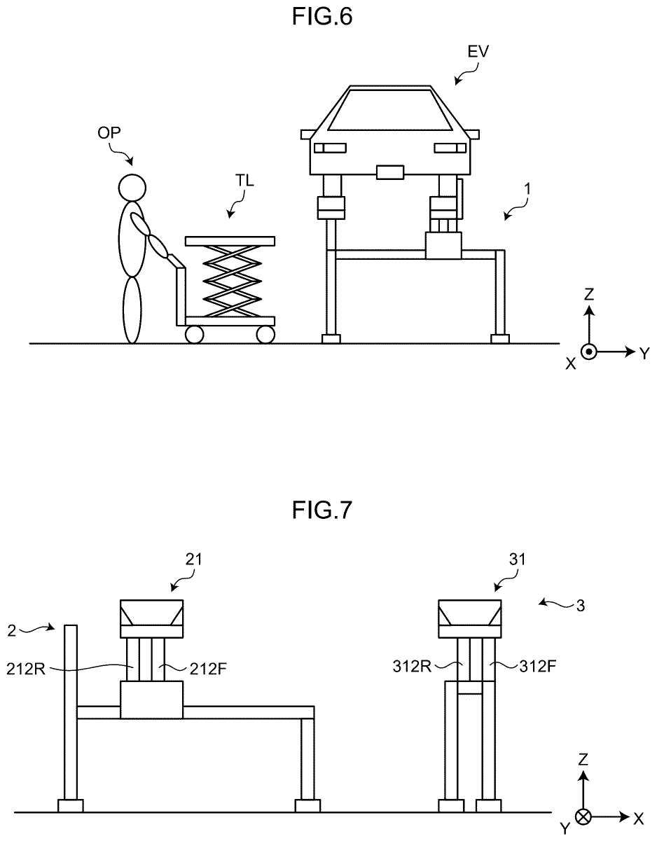

FIG. 6 is a view for describing work of taking out the driving battery BAT from the battery electric vehicle EV. An operator OP puts a table lift TL for placing the driving battery BAT under the battery electric vehicle EV from between the first frame rack 3 and the second frame rack 2. The operator OP places the driving battery BAT taken out from under the floor of the battery electric vehicle EV on the table lift TL, and carries out the driving battery BAT from between the first frame rack 3 and the second frame rack 2.

Here, in the battery electric vehicle EV, the wheels are supported instead of a portion of a rocker panel. Thus, the driving battery BAT taken out from under the floor does not interfere with the portions supporting the battery electric vehicle EV, and the driving battery BAT can be easily taken out. In addition, in the vehicle frame rack 1, the position in the X-axis direction of the rear wheel support portion 20 can be adjusted in accordance with L of the wheelbase, and the interval between the third support portion 21 and the fourth support portion 22 and the interval between the first support portion 31 and the second support portion 32 can be adjusted in accordance with W of the tread width, whereby the driving battery BAT can be removed with respect to various vehicle types from small vehicles to large vehicles. In addition, since the interval between the third support portion 21 and the fourth support portion 22 and the interval between the first support portion 31 and the second support portion 32 can be separately adjusted, the vehicle frame rack 1 can support even a battery electric vehicle EV having different tread widths in front wheels and rear wheels. In addition, since the vehicle frame rack 1 is separated into the first frame rack 3 that supports the front wheels and the second frame rack 2 that supports the rear wheels, when the operator OP and the table lift TL move below the battery electric vehicle EV, there is no obstacle to prevent movement on flow lines of the operator OP and the table lift TL, and the work can be efficiently performed. Furthermore, in the present embodiment, since each of the movable portions is configured to sandwich the beam, it is possible to prevent a fall from the beam. Even in a case where the vehicle placed on the vehicle frame rack 1 is a hybrid electric vehicle or a plug-in hybrid electric vehicle, various vehicle types can be placed and parts can be removed from under the floor. In a case where the vehicle placed on the vehicle frame rack 1 is an engine vehicle, various types of vehicles can be placed and work under the floor can be performed.

### Modified Example

Although the embodiment of the present disclosure has been described above, the present disclosure is not limited to the above-described embodiment, and can be implemented in various other forms. For example, the present disclosure may be implemented with the above-described embodiment being modified as follows. Note that the above-described embodiment and the following modification examples may be combined. The present disclosure also includes configurations formed by appropriate combination of components of the above-described embodiment and modification examples. In addition, further effects and modification examples can be easily derived by those skilled in the art. Thus, a wider aspect of the present disclosure is not limited to the above embodiment and modification example, and various modifications can be made.

FIG. 7 is a front view of a vehicle frame rack according to a modification example of the present disclosure. In the present disclosure, a position of a support leg 212F may be shifted on a side in the −X direction from the position illustrated in FIG. 1B, and a position of a support leg 312R may be shifted in the +X direction from the position illustrated in FIG. 1B. In this modification example, even when L of a wheelbase is the same, a distance from the support leg 212F to the support leg 312R becomes long, whereby a wide space below a battery electric vehicle EV can be secured.

In the present disclosure, a fourth support portion 22 may not include a side plate 222, and a second support portion 32 may not include a side plate 322. In this configuration, in a case where a battery electric vehicle EV is placed on a vehicle frame rack 1, an interval between a first support portion 31 and the second support portion 32 is adjusted in advance in accordance with W of a tread width of the battery electric vehicle, and an interval between a third support portion 21 and the fourth support portion 22 is adjusted.

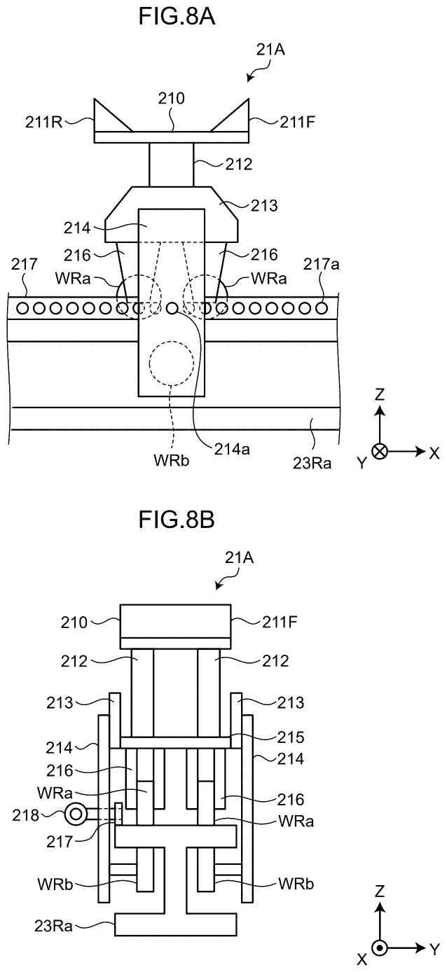

FIG. 8A and FIG. 8B are schematic views of a third support portion 21A according to a modification example of the present disclosure. A beam 23Ra is H-beam steel and is a member laid from a support column 25R to a support column 26R in the X-axis direction instead of a beam 23R. A fixed plate 217 that is a belt-shaped plate made of metal is fixed in the X-axis direction to an end portion in the −Y direction on an upper surface of the beam 23Ra. A plurality of through holes 217a penetrating in the Y-axis direction is formed in the fixed plate 217 in the X-axis direction. A support leg 212 is a member that supports a bottom plate 210, and is fixed to a base portion 215. The base portion 215 is a rectangular plate-shaped member, and a plate-shaped trapezoidal side plate 213 is fixed to each of ends in the +Y direction and the −Y direction. A wheel support portion 216 that supports a wheel WRa is fixed below the base portion 215. A rectangular plate-shaped side plate 214 is fixed to each of the side plates 213. The side plate 214 supports a wheel WRb. The third support portion 21A sandwiches the beam 23Ra in the +Z direction and the −Y direction by the wheel WRa and a wheel WRb, and is movable in the X-axis direction. According to this configuration, since the beam 23R is vertically sandwiched between the wheel WRa and the wheel WRb and the beam 23Ra is sandwiched in the Y-axis direction by the side plates 214, it is possible to prevent the third support portion 21A from falling off from the beam 23Ra. In addition, a through hole 214a penetrating in the Y-axis direction is formed in each of the side plates 214. A rod-like portion of a pin 218 having a shape of an eyebolt is inserted into the through hole 214a and the through hole 217a in the −Y direction. After a right rear wheel of a battery electric vehicle EV is placed on the third support portion 21A, an operator inserts the pin 218 into both the through hole 214a and the through hole 217a from a side in the −Y direction. When the pin 218 is inserted into both the through hole 214a and the through hole 217a, even when force in the X-axis direction acts on the third support portion 21A, the pin 218 is fixed to the fixed plate 217. Thus, a rear wheel support portion 20, a fourth support portion 22, and the third support portion 21A can be prevented from moving in the X axis direction. Note that the fourth support portion 22 and a second support portion 32 may have the same configuration as the third support portion 21A, a corresponding fixed plate 217 may be provided on a beam, and movement in the Y-axis direction may be prevented by a pin 218.

In the present disclosure, a fourth support portion 22 may be fixed on a movable portion 20L, a third support portion 21 may be movable in the Y axis direction, a second support portion 32 may be fixed on a beam 33L, and a first support portion 31 may be movable in the Y-axis direction. In a case of this modification example, in this case, a battery electric vehicle EV is carried by a forklift FT from the +Y-axis direction toward the −Y-axis direction and placed on a vehicle frame rack 1.

A front wheel may be placed on a second frame rack 2, and a rear wheel may be placed on a first frame rack 3. In this case, a fourth support portion 22 supports a right front wheel of a battery electric vehicle EV, a third support portion 21 supports a left front wheel of the battery electric vehicle EV, a second support portion 32 supports a right rear wheel of the battery electric vehicle EV, and a first support portion 31 supports a left rear wheel of the battery electric vehicle EV.

According to the vehicle frame rack of the present disclosure, it is possible to facilitate leveling of a vehicle and to achieve high safety of work of removing a heavy object such as a battery

As a result, since it becomes possible to remove the underfloor driving battery of any vehicle by adjusting a position of each of support portions according to a vehicle size, and a space for allowing a person or a jig to pass through is generated at least in right-left directions of the vehicle by separation of leg portions in a front-rear direction, workability of battery replacement or the like is improved, leveling of the vehicle can be facilitated, and high safety of work of removing a heavy object such as a battery can be achieved.

As a result, after the movable support portion is moved according to the dimensions of the wheelbase and the tread of the vehicle, it is possible to omit time and effort of when a fixing metal fitting for preventing movement or the like is set, and it is possible to easily perform fixing.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle frame rack comprising:
a first support portion that supports a first wheel of a vehicle;
a second support portion that supports a second wheel of the vehicle which wheel is separated from the first wheel in a width direction of the vehicle;
a third support portion that supports a third wheel of the vehicle which wheel is separated from the first wheel in a length direction of the vehicle;
a fourth support portion that supports a fourth wheel of the vehicle which wheel is separated from the third wheel in the width direction of the vehicle;
a first frame rack having the first support portion and the second support portion at a predetermined height; and
a second frame rack separated from the first frame rack and having the third support portion and the fourth support portion at a predetermined height, wherein
in the first frame rack, the first support portion or the second support portion moves in the width direction of the vehicle,
in the second frame rack, the third support portion and the fourth support portion move in a length direction of the vehicle,
the third support portion or the fourth support portion also moves in the width direction,
the first support portion includes, between itself and the first frame rack, a first height display portion and a first lifting adjustment portion,
the second support portion includes, between itself and the first frame rack, a second height display portion and a second lifting adjustment portion,
the third support portion includes, between itself and the second frame rack, a third height display portion and a third lifting adjustment portion, and
the fourth support portion includes, between itself and the second frame rack, a fourth height display portion and a fourth lifting adjustment portion.

2. The vehicle frame rack according to claim 1, wherein
each of the first support portion, the second support portion, the third support portion, and the fourth support portion includes a wheel stopper that stops rotation of a wheel of the vehicle.

3. The vehicle frame rack according to claim 1, wherein
the first frame rack includes a first beam laid in the width direction,
the first support portion or the second support portion that moves in the width direction sandwiches the first beam between wheels from upper and lower sides and moves in the width direction along the first beam,
the second frame rack includes a second beam laid in the length direction and a first movable portion that moves along the second beam,
the first movable portion sandwiches the second beam with wheels from the upper and lower sides, and moves in the length direction along the second beam,
the first movable portion includes a third beam laid in the width direction and a second movable portion that moves along the third beam, and
the second movable portion sandwiches the third beam with wheels from the upper and lower sides, and moves in the width direction along the third beam.

4. The vehicle frame rack according to claim 1, wherein
a support portion that moves in the width direction in the first support portion, the second support portion, the third support portion, and the fourth support portion includes a side plate in contact with a side surface of a supported wheel, and moves in the width direction by being pushed by the wheel.

5. A vehicle frame rack comprising:
a first support portion that supports a first wheel of a vehicle;
a second support portion that supports a second wheel of the vehicle which wheel is separated from the first wheel in a width direction of the vehicle;
a third support portion that supports a third wheel of the vehicle which wheel is separated from the first wheel in a length direction of the vehicle;
a fourth support portion that supports a fourth wheel of the vehicle which wheel is separated from the third wheel in the width direction of the vehicle;
a first frame rack having the first support portion and the second support portion at a predetermined height; and
a second frame rack separated from the first frame rack and having the third support portion and the fourth support portion at a predetermined height, wherein
in the first frame rack, the first support portion or the second support portion moves in the width direction of the vehicle,
in the second frame rack, the third support portion and the fourth support portion move in the length direction of the vehicle,
the third support portion or the fourth support portion also moves in the width direction,
the first frame rack includes a first beam laid in the width direction,
the first beam includes a first beam bottom portion, and first beam side wall portions at both ends in the width direction above the first beam bottom portion,
the first support portion or the second support portion includes, on a bottom surface thereof, a first spring, which is deformed by weight of the vehicle, and a first wheel or a second spring and a second wheel, and the first wheel or the second wheel moves inside in the width direction the first beam side wall portions while rolling on the first beam bottom portion,
the second frame rack includes a second beam laid in the length direction, and a first movable portion that moves along the second beam,
the first movable portion includes the third support portion,
the second beam includes a second beam bottom portion, and second beam side wall portions at both ends in the width direction above the second beam bottom portion,
the first movable portion includes, on a bottom surface thereof, a third spring, which is deformed by the weight of the vehicle, and a third wheel, and the third wheel moves inside the second beam side wall portions in the width direction while rolling on the second beam bottom portion,
the first movable portion further includes a third beam laid in the width direction and a second movable portion that moves along the third beam,
the second movable portion includes the fourth support portion,
the third beam includes a third beam bottom portion, and third beam side wall portions at both ends in the width direction above the third beam bottom portion,
the second movable portion includes, on a bottom surface thereof, a fourth spring, which is deformed by the weight of the vehicle, and a fourth wheel, and the fourth wheel moves inside the third beam side wall portions in the width direction while rolling on the third beam bottom portion,
a dimension in the height direction of the first spring and the first wheel or a dimension in the height direction of the second spring and the second wheel in a state in which the vehicle is not mounted on the vehicle frame rack is larger than a dimension in the height direction of the first beam side wall portions, and the dimension in the height direction of the first spring and the first wheel or the dimension in the height direction of the second spring and the second wheel in a state in which the vehicle is mounted on the vehicle frame rack is equal to or smaller than the dimension in the height direction of the first beam side wall portions,
a dimension in the height direction of the third spring and the third wheel in a state in which the vehicle is not mounted on the vehicle frame rack is larger than a dimension in the height direction of the second beam side wall portions, and the dimension in the height direction of the third spring and the third wheel in a state in which the vehicle is mounted on the vehicle frame rack is equal to or smaller than the dimension in the height direction of the second beam side wall portions, and
a dimension in the height direction of the fourth spring and the fourth wheel in a state in which the vehicle is not mounted on the vehicle frame rack is larger than a dimension in the height direction of the third beam side wall portions, and the dimension in the height direction of the fourth spring and the fourth wheel in a state in which the vehicle is mounted on the vehicle frame rack is equal to or smaller than the dimension in the height direction of the third beam side wall portions.

6. The vehicle frame rack according to claim 5, wherein
each of the first support portion, the second support portion, the third support portion, and the fourth support portion includes a wheel stopper that stops rotation of a wheel of the vehicle.

7. The vehicle frame rack according to claim 5, wherein
the first frame rack includes a first beam laid in the width direction,
the first support portion or the second support portion that moves in the width direction sandwiches the first beam between wheels from upper and lower sides and moves in the width direction along the first beam,
the second frame rack includes a second beam laid in the length direction and a first movable portion that moves along the second beam,
the first movable portion sandwiches the second beam with wheels from the upper and lower sides, and moves in the length direction along the second beam,
the first movable portion includes a third beam laid in the width direction and a second movable portion that moves along the third beam, and
the second movable portion sandwiches the third beam with wheels from the upper and lower sides, and moves in the width direction along the third beam.

8. The vehicle frame rack according to claim 5, wherein
a support portion that moves in the width direction in the first support portion, the second support portion, the third support portion, and the fourth support portion includes a side plate in contact with a side surface of a supported wheel, and moves in the width direction by being pushed by the wheel.
